(19) United States
(12) Patent Application Publication
(10) Pub. No.: US 2011/0277597 A1
(43) Pub. Date: Nov. 17, 2011

(54) Piercing cap drive socket

(76) Inventor: Mathys Marion Van Ryswyk, Edwardsville, IL (US)

(21) Appl. No.: 12/800,214

(22) Filed: May 11, 2010

(51) Int. Cl. B25B 13/50; B25B 13/06; B23P 11/00

(52) U.S. Cl. 81/124.2; 29/432

(57) ABSTRACT

A tool for installing a saddle tee with a piercing cap on a poly pipe includes a housing having a top, a bottom and side portions. The top portion is adapted for receiving a drive device. The bottom portion is adapted with at least one pair of fins shaped to couple to wings on the piercing cap to apply a rotational force to the piercing cap. The side portion of the housing has a slot to accommodate an angular fitting that may be installed in the piercing cap. Such a tool may be a drive socket. The drive device attached to the top may be permanently attached or may be a quick release fitting. The drive device may include an extension bar, a T-handle, a speed handle, or a ratchet. The drive device may connect to a portable power drill to turn the drive socket.

### BACKGROUND OF THE INVENTION

1. Technical Field

The invention relates to a tool in the field of drive sockets, the tool configured to install a piercing cap into a saddle tee fitting on a poly tube.

2. Related Art

A common use for poly tubes is the transport of fluids from one location to another. For instance, poly tubes may be used to direct water for irrigation on golf courses and in residential yards to in-ground sprinklers. In order to simplify manufacturing, sprinklers are installed at the job site after the poly pipe is positioned. The placement and installation of the sprinkler fittings is effected through the use of saddle tee fittings that accommodate the installation of a piercing cap which pierces the wall of the poly-tube to access water at the desired sprinkler location. Accordingly, a tool for easing the installation of the piercing cap is required.

### SUMMARY

A tool for installing a saddle tee and piercing cap onto a poly tube for irrigation sprinklers includes a housing with a top that is adapted for receiving a drive device. The housing also has at least one slot in its side to accommodate an angular fitting. A bottom portion of the housing is adapted with fins (extended edges) shaped to couple to wings extending from the top side of the piercing cap to apply a rotational force to the piercing cap. Preferably, the drive device is permanently attached to the top of the tool such as an extension bar of various lengths commonly used with sockets. Here, the drive device may then be attached to a portable drill. Alternatively however, the drive device may have quick-disconnects. Thus, the drive device may be an extension bar, ratchet, speed handle, T-handle or breaker bar.

The tool for installing the saddle tee and piercing cap can be a drive socket with a housing with a top adapted to receiving the drive device. The drive device may be an extension bar permanently affixed to the top of the drive socket. Thus, the drive device can be connected to a portable drill. The side of the socket housing has at least one slot which is adapted to receive an angular-type fitting that might be installed in the piercing cap. Preferably, the housing has two slots, one directly opposite of the other slot. The bottom portion of the housing for the drive socket has fins that extend from the cylindrical side wall. The fins are shaped to interact with the wings that extend from the edges of the piercing cap. The fins apply a rotational force to the wings, wherein the fins extend from the side wall of the drive socket that form the open slot or slots. Preferably, the fins are paired and on opposite sides of the drive socket.

A method of using the piercing cap drive socket is for the installation of sprinkler heads requiring saddle tees on in-ground irrigation systems that use poly pipe. Generally, a saddle tee is fitted to the poly pipe at a desired location. A piercing cap is then mated to the saddle tee and the piercing cap is loosely screwed into the threads within the saddle tee. The piercing cap drive socket is fitted to the piercing cap and the drive socket is rotated. The rotation causes the piercing cap to be drawn into the saddle tee while simultaneously piercing the side of the poly pipe. Additional rotation of the piercing cap drive socket, and the piercing cap, causes a seal on the piercing cap to mate with the wall of the poly pipe and provide a leak-tight installation. An angular fitting may be installed in the piercing cap and the slot or slots of the piercing cap drive socket accommodate the angular fitting.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the claims below.

### BRIEF DESCRIPTION OF THE DRAWINGS

The invention can be better understood with reference to the following diagrams. The diagrams of the saddle tee, piercing cap and piercing cap drive socket are not necessarily to scale, an emphasis instead being placed upon illustrating the principles of the piercing cap drive socket. Moreover, in the figures, like-referenced numerals designate corresponding parts and steps throughout the different views.

FIG. 1 is a prior art hand tool with a saddle tee and piercing cap.

FIG. 2 is a depiction of the prior art tool attaching a piercing cap to a saddle tee.

FIG. 3 depicts a piercing cap drive socket.

FIG. 4 depicts an assembled saddle tee-piercing cap with an attached angular fitting.

FIG. 5 is a top view of a piercing cap drive socket.

FIG. 6 is a depiction of the piercing cap drive socket attaching a piercing cap to a saddle tee.

### DETAILED DESCRIPTION OF THE PREFERRED EMBODIMENTS

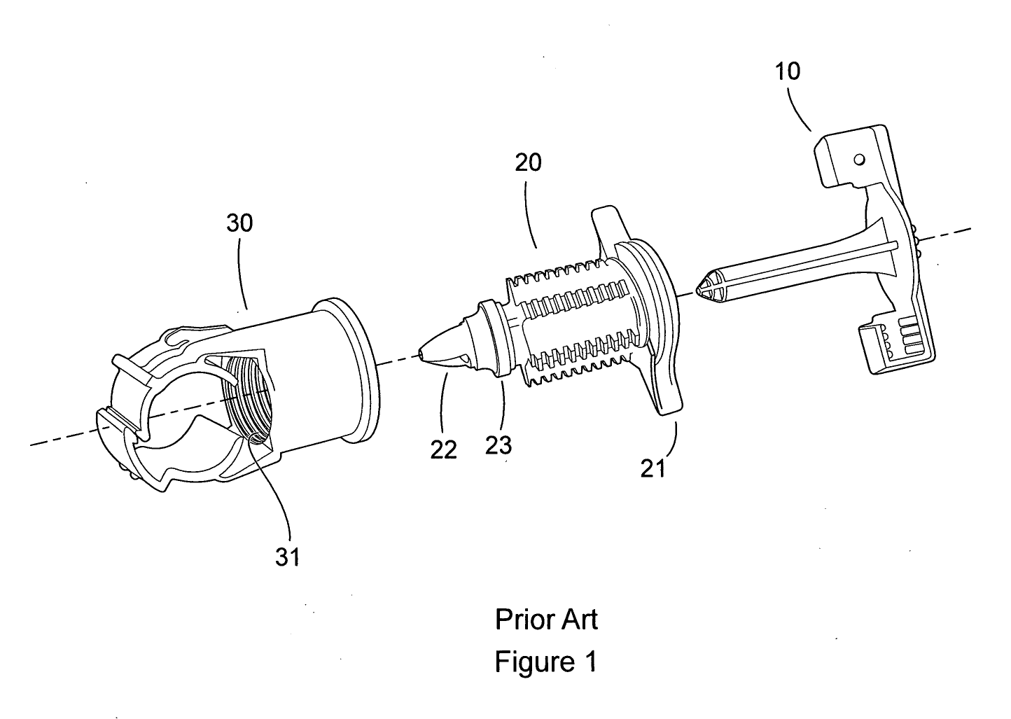

A poly pipe for transporting water for irrigation purposes is generally laid out across a landscape such as a golf course or residential yard prior to the installation of the sprinkler fittings. After the poly pipe is positioned, the sprinklers and fittings are attached. Since the poly pipe has no pre-fabricated openings, the installation of the fitting generally requires the side wall of the poly pipe be breached to access the water. As shown in FIG. 1, a fitting for breaching the poly pipe has two main parts: a saddle tee 30 that straps around the pipe and a piercing cap 20 that will pierce the side of the poly pipe as the piercing cap 20 is screwed into the saddle tee 30. Since a rotational force will be required to provide the ultimate piercing of the pipe, a prior art tool 10 was made available to assist in rotating the piercing cap. However, the prior art tool 10 generally used for this task fatigues workers' hands and arms thereby reducing productivity after an extended day of installation.

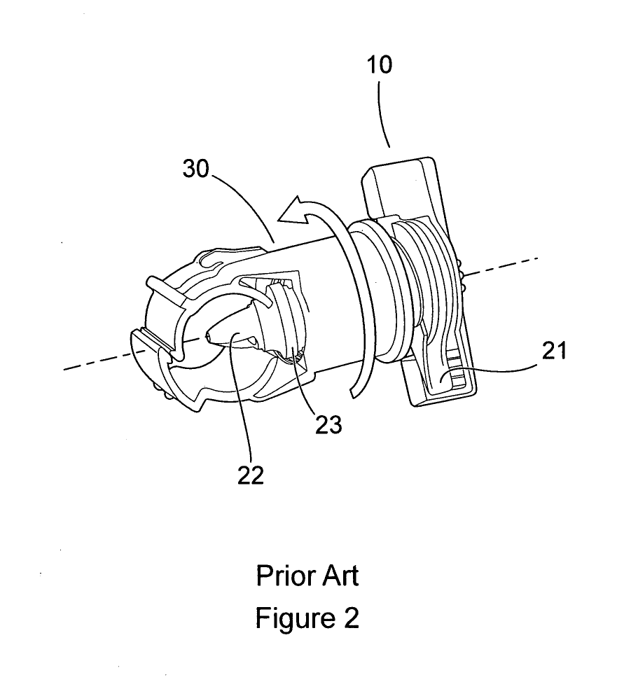

The prior art installation of the fitting is accomplished by placing the saddle tee 30 around the poly pipe (not shown). The piercing cap 20 is then positioned in the saddle tee 30. Once in place, the hand tool 10 is inserted into the piercing cap 20 so that it makes contact with the wings 21 on the piercing cap 20 as illustrated in FIG. 2. When the tool 10 is rotated, it applies the rotational force to the wings 21 much like a wing nut on a bolt. As the hand tool 10 is turned, it screws the piercing cap 20 into the threads 31 (as illustrated in FIG. 1) of the saddle tee 30. As the rotation of the piercing cap 20 proceeds further, the threads 31 draw the piercing cap 20 further into the saddle tee 30, causing the pointed end 22 of the piercing cap to contact and eventually puncture the side of the poly tube. As the piercing cap 20 is tightened further, the seal 23 on the piercing cap 20 in contact with the side of the poly pipe forms a leak-tight installation.

Although effective in theory, the prior art hand tool 10 lacks the application of anything other than a manual rotational force exerted by a worker's lower arm and hand muscles which tire as the number of installations of saddle tees 20 and piercing caps 30 increase. Moreover, the end of the prior art tool 10, when inserted into the center of the piercing cap 20, prevents the installation of any fitting into the top of the piercing cap 20. Thus, an extra installation step is required to install a fitting into the piercing cap 20 after it is affixed to the poly pipe. Therefore, a need for a tool that provides a non-fatiguing and more productive method of assembly for an irrigation system is required.

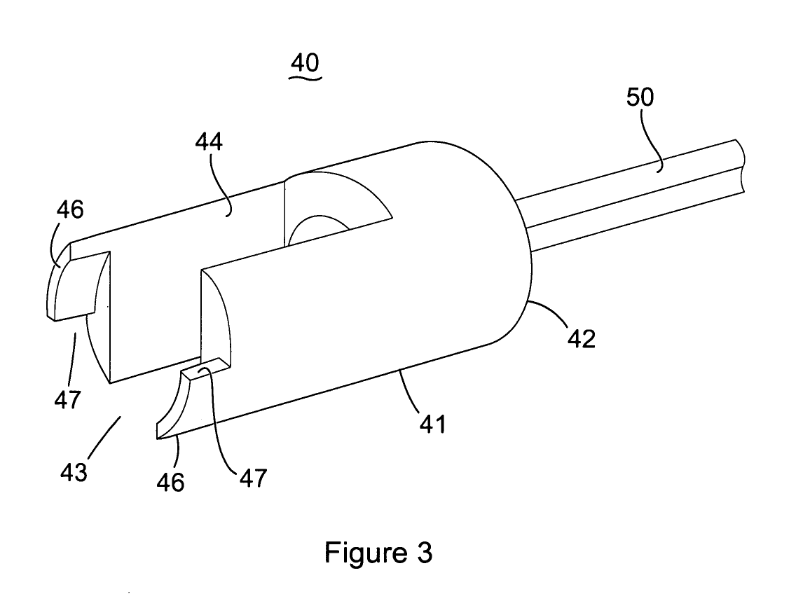

A piercing cap drive socket 40 is shown in FIG. 3. The preferred piercing cap drive socket 40 is a generally cylindrically-shaped tool having a housing 41, a top 42, and a bottom 43. The housing 41 is generally hollow.

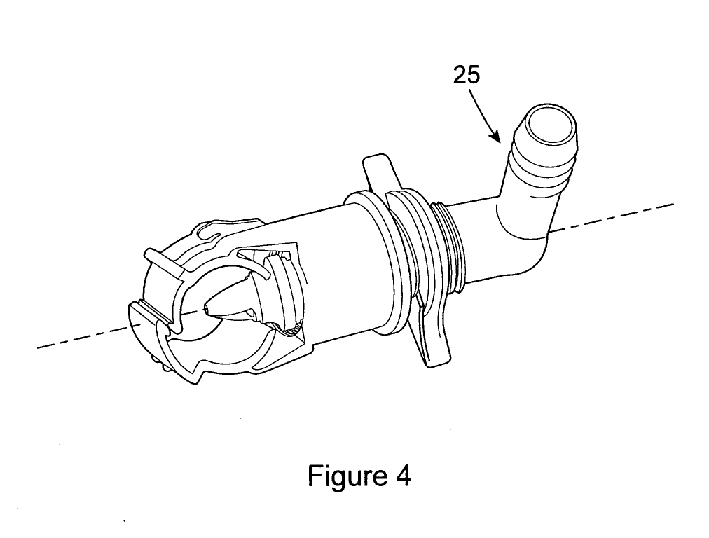

The preferred embodiment of the drive socket 40 has a housing 41 that has a depth for accommodating various-sized fittings that may be inserted into the top of a piercing cap 20. Additionally, the depth may be different to accommodate various-sized fittings. Further, the housing 41 preferably has a slot 44 formed in the side wall. The slot 44 accommodates various fittings that may protrude from the top of the piercing cap 20 at an angle. These fittings may be pre-attached to the piercing cap 20 prior to installation on the poly pipe. FIG. 4 shows an example of such a fitting 25 that may be attached to the top of the piercing cap 20. However, the preferable embodiment of the drive socket 40 has two slots 44, one slot 44 opposite the other.

As shown, an angular fitting 25 is perpendicular to the axis of the piercing cap 20 and perpendicular to the flow of a fluid such as water as it flows through the piercing cap 20 when installed. Preferably, the end of the fitting 25 would be rotated about ninety degrees from the wings 21 of the piercing cap 20. However, this is not necessary as long as when the drive socket 40 is fitted to the piercing cap 20, the fitting 25 is protected from the rotational forces that may be applied to the wings 21 of the piercing cap 20.

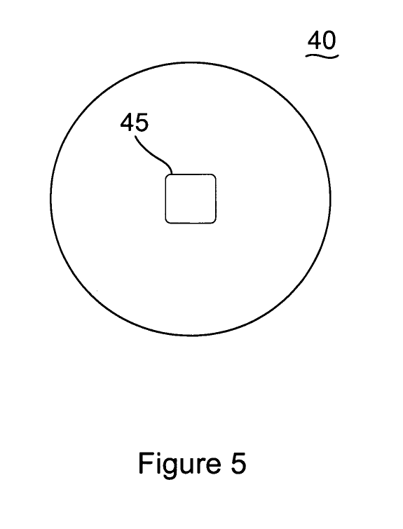

The top 42 of the housing 40 may be adapted so that it can receive a drive device 50. As many prior art sockets have openings to receive a ratchet, T-handle, breaker bar, speed handle, or an extension bar, the piercing cap drive socket 40 may be outfitted the same way. The opening 45 as shown in FIG. 5 may accommodate a ¼-inch, ⅜-inch or even a ½-inch drive from any of the aforementioned tools. Additionally, it may have a metric standard drive as well, thus the size of the opening is not important. If the piercing cap drive socket 40 is outfitted with an extension bar, the extension bar may be of any length that is practical for the field work. Preferably, the extension bar may be permanently attached to the top 42 of the piercing cap drive socket 40 in order to accommodate the field conditions so that the socket 40 is not accidently removed or becomes unattached from the drive 50. Thus, the permanent attachment of the piercing cap drive socket 40 to the drive device 50 removes the possibility that the drive socket 40 will become separated and get lost.

In a preferred embodiment, the drive device 50 is connected to a portable electric drill. Such an electric drill may be outfitted with a battery making the whole tool assembly portable.

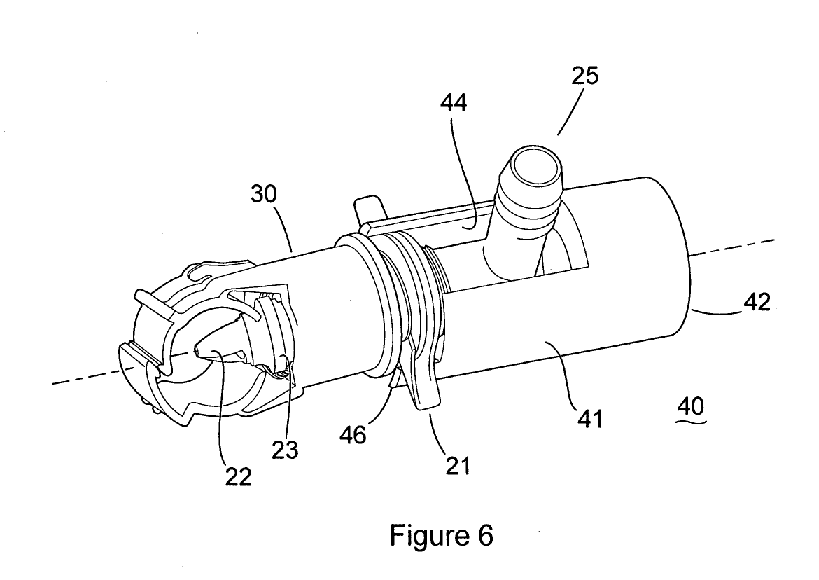

The bottom 43 of the socket 40 is adapted to make contact with the wings 21 of the piercing cap 20. As shown in FIG. 3, the bottom 43 includes at least two fins 46 that extend downward from the housing 41. The fins 46 are adapted to interact with the wings 21, applying a rotational force as the drive socket 40 is turned. The fins 46 will contact the wings 21 as shown in FIG. 6. Although FIG. 3 shows the contact points 47 of the fins 46 at a ninety (90) degree angle from the center of the slots 44, it is not necessary that this angle be precise. The fins 46 may be placed at any orientation so that the tool supports any anticipated fitting that may installed in the end of the piercing cap 20.

By way of example, installation of a sprinkler fitting is accomplished by first placing the saddle 30 around the poly pipe (not shown). A piercing cap 20 is then positioned in the saddle 30 by mating it to the female threads and turning it so it is loosely fitted. Once in place, the piercing cap drive socket 40 is mated to the piercing cap 20 so that the fins 46 makes contact with the wings 21 of the piercing cap 20 as illustrated in FIG. 6. In this example, a fitting 25 is already installed in the piercing cap 20. Since the fitting 25 is perpendicular, it extends through the slot 44. Here, the fitting 25 receives no torque or rotational force from the drive socket 40. When the drive socket 40 is rotated, it applies the rotational force only to the wings 21 of the piercing cap 20. As the piercing cap 20 is turned, the threads 31 of the saddle 30 draw the piercing cap 20 further into the saddle 30, causing the pointed end 22 of the piercing cap 20 to contact and eventually puncture the side of the poly tube. As the piercing cap 20 is tightened further, the seal 23 on the piercing cap 20 forms a leak-tight installation with the side of the poly tube.

The drive device 50 that is connected to the piercing cap drive socket 40 for providing the rotational force may be any sized-extension bar, ratchet, T-handle or speed handle. Preferably however, an extension bar is the drive device 50 and is permanently affixed to the top 41 of the drive socket 40. It is then preferable that the drive device 50 be mated to a portable hand drill (generally cordless) to speed installation of irrigation systems. Such a set-up is beneficial to the worker and reducing occupational injuries.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A tool for driving a piercing cap comprising:
a) a housing with a top, a bottom and side portions;
b) the top portion being adapted for receiving a drive device;
c) the bottom portion adapted with at least one pair of fins shaped to couple to wings on the piercing cap to apply a rotational force to the piercing cap;
d) the side portion having a slot to accommodate an angular fitting installed in the piercing cap.

2. The tool of claim 1, wherein the drive device is an extension bar.

3. The tool of claim 2, wherein the drive device is permanently attached to the top portion.

4. The tool of claim 1, wherein the drive device is connected to a portable drill.

5. The tool of claim 1, wherein the drive device is one of a T-handle, breaker bar, speed handle, and ratchet.

6. The tool of claim 1 wherein side portion has two slots, one slot opposite from the other.

7. A drive socket comprising:
a) a cylindrical housing being generally hollow, the housing having a top, a side and a bottom portion;
b) the top portion of the cylindrical housing being adapted for receiving a drive device;
c) the side portion having at least one slot adapted to receive an angular-type fitting installed in a piercing cap;
d) a bottom portion having fins extending from the cylindrical wall, the fins shaped to interact with wings extending from the edges of the piercing connector so that the fins apply a rotational force on the piercing connector, wherein the fins extend from the walls that form the open slots.

8. The drive socket of claim 7, wherein the contact point of the fins with the wings is positioned about ninety degrees from the center of opening of the open slots.

9. The drive socket of claim 7, wherein the top portion receives one of an extension bar, speed handle, T-handle, and ratchet.

10. The drive socket of claim 9, wherein the extension bar is permanently attached to the top portion.

11. The drive socket of claim 7, wherein the side portion has two slots, one slot opposite the other.

12. A method for installing a fitting for a sprinkler on a poly pipe, the method comprising:
a) installing a saddle tee on the poly pipe;
b) inserting a piercing cap into the saddle tee;
c) affixing a piercing cap drive socket to the piercing cap;
d) rotationally driving the drive socket so that the saddle tee draws the piercing cap into a side wall of the poly pipe, wherein the piercing cap pierces the side wall and upon further rotation seals itself against the side wall.

13. The method of claim 12 wherein one of a T-handle, extension bar, speed handle, and ratchet is used to drive the piercing cap drive socket.

14. The method of claim 12 wherein a portable drill is used to drive the piercing cap drive socket.
